(19) United States
(12) Patent Application Publication
(10) Pub. No.: US 2014/0110096 A1
(43) Pub. Date: Apr. 24, 2014

(54) MAXIMIZING THE LIGHTING EFFICIENCY OF LED LAMPS

(71) Applicant: LUMEN LED, HAYWARD, CA (US)

(72) Inventors: SHELDON STEWART NORBERG, ALAMEDA, CA (US); JOHN ALBERT MASSA, ALAMEDA, CA (US); DAVID R. GOODSON, CASTRO VALLEY, CA (US); CHRISTOPHER MARQUIS, HAYWARD, CA (US); FELIX MING HAN CHAI, SHENZHEN (CN)

(73) Assignee: LUMEN LED, HAYWARD, CA (US)

(21) Appl. No.: 14/058,230

(22) Filed: Oct. 19, 2013

Related U.S. Application Data
(60) Provisional application No. 61/716,376, filed on Oct. 19, 2012.

(51) Int. Cl. F21V 29/00; F21V 17/04; F21K 99/00

(52) U.S. Cl. CPC F21V 29/22; F21K 9/50; F21V 17/04
USPC 165/185; 362/249.02; 29/407.1; 29/407.05

(57) ABSTRACT

Disclosed is a method of making an LED light bulb using a plurality of surface mount light emitting diodes mounted on a variety of semiregular polyhedrons and optimizing the number and placement of the surface mount light emitting diodes for the widest lighting angle (to achieve as close to 360-degrees in three dimensions) with a heat sink matched to the thermal output of the surface mount light emitting diodes and the heat conductive capacity of the polyhedron. Also described are a light emitting diode light bulb made using a plurality of surface mount light emitting diodes mounted on a variety of semiregular polyhedrons. Some embodiments may include a heat conductor comprising a plurality of curved-T shaped heat fins.

### CROSS-REFERENCE TO RELATED APPLICATION

This application claims the benefit of priority of U.S. Provisional Patent Application 61/716376 filed Oct. 19, 2012 and titled “A Method Of Maximizing The Lighting Efficiency Of LEDs,” the disclosure of which is incorporated by reference. This application is related to the Design patent application Ser. No. 29/470,333 filed Oct. 19, 2013 and titled “Radial Heat Conductor”.

### BACKGROUND OF THE INVENTION

1. Field of Invention

The invention relates generally to the field of electric lighting and specifically to lighting using surface mount light emitting diodes on semiregular polyhedrons.

2. Description of Related Art

LED lamps decrease energy consumption, with surface mounted LED (sm-LED) lamps currently reigning supreme in the light-to-energy competition. Surface mounted LED, though, are flat and must be mounted on a flat surface. To increase light distribution from the flat configurations, such lamps typically have many sm-LEDs on multiple flat geometries for greater light distribution. To get more light or to have light in a 360-degree pattern, more LEDs are added.

More LEDs, however, create other problems. For one, consumers want bulbs that emulate existing lamp shapes and their lighting patterns. To achieve these expectations, manufacturers place the sm-LEDs closer together. Surface mounted LEDs, however, generate heat, and an LED's lifetime and color stability are inversely proportional to its operating temperature. The tradeoff is therefore life or light. Attempts to reduce the junction temperature of the LEDs include various changes to the mounting structure, the core heat sink, the spreader plate, and the lamp body. The shape and size limitations, however, limit these changes to a marginal improvement in lamp light and life, and make standards compliance a problem.

### SUMMARY OF THE INVENTION

Embodiments are directed to method of making an LED light bulb using a plurality of surface mount light emitting diodes mounted on a variety of semiregular polyhedrons and optimizing the number and placement of the surface mount light emitting diodes for the widest lighting angle (to achieve as close to 360-degrees in three dimensions) with a heat sink matched to the thermal output of the surface mount light emitting diodes and the heat conductive capacity of the prismatic polyhedron.

A method for making an LED lamp comprises evaluating a surface mount light emitting diode having a beam angle, chip dimensions, efficacy curve and heat-sinking requirements, determining an arrangement of beam angles of a plurality of the surface mount light emitting diodes such that the arrangement covers a rough approximation of 360-degrees, evaluating the plurality of the surface mount light emitting diodes as to minimize the plurality of the surface mount light emitting diodes as to best emulate a point-source of illumination, selecting a polyhedron having a material composition for a maximal thermal conduction and size for optimal lighting angle to comport with the minimized arrangement of the plurality of the surface mount light emitting diodes covering an approximation of 360-degrees, and mounting the minimized number of the plurality of the surface mount light emitting diodes on the polyhedron as to best emulate a point-source of illumination.

Another method comprises matching a light output of a plurality of surface mount light emitting diodes to a predetermined light output requirement, selecting a prismatic polyhedron having a suitable size for the plurality of surface mount light emitting diodes, selecting a thermally conductive material suitable for affixing surface mount light emitting diodes, selecting a thermally conductive material for heat sink, affixing the surface mount light emitting diodes and power supply to the prismatic polyhedron, affixing the heat sink to a prismatic polyhedron along with and securing a diffuser to a base and over the prismatic polyhedron.

In some embodiments, the polyhedron shape is known as a “Prismatic Uniform Polyhedron” (PUP), with, in some embodiments, a specially designed heat sink, a specially designed outer bulb, or both.

In some embodiments, the polyhedron shape is known as a “Truncated Prismatic Polyhedron” (TPP), with, in some embodiments, a specially designed heat sink, a specially designed outer bulb, or both.

In some embodiments, the polyhedron shape is known as an Archimedean solid, with, in some embodiments, a specially designed heat sink, a specially designed outer bulb, or both.

In some embodiments, the specially designed heat sink may be made of copper, aluminum, ceramic, plastic, or other polymer.

### BRIEF DESCRIPTION OF THE DRAWINGS

FIG. 1 shows a diagram (100) of a luminous intensity distribution diagram for an omnidirectional lamp. The lamp is hypothetically intended to meet a certain illumination standards approximately consistent with lighting products typically used by consumers.

FIG. 2 shows a method (200) of making LED lamp comprising a minimized number of surface mount light emitting diodes on a polyhedron as to best emulate a point-source of illumination while covering an approximation of 360-degrees to be Energy Star compliant

FIG. 3 shows an exemplary embodiment (300) of an optimized and minimized surface mount light emitting diode lamp arrangement showing the light dispersion pattern of a dodecahedron (12-sided polyhedron) configured with a plurality of light emitting diodes using the method above.

FIG. 4 shows an embodiment (400) of a semiregular polyhedron known as a prismatic uniform polyhedron configured with a plurality of light emitting diodes. This specific polyhedron is known an octagonal prism (400)

FIG. 5 shows an embodiment (500) of a semiregular prismatic uniform polyhedron antiprism known as an octagonal antiprism configured with a plurality of light emitting diodes as an LED Lamp.

FIG. 6 shows an embodiment (600) of a Truncated Prismatic Uniform Polyhedron known as a Cuboctahedron (a truncated cube), which is also part of a finite group known as Archimedean solids, configured with a plurality of surface mounted light emitting diodes.

FIGS. 7, 8, 9 and 10 show a specially designed heat sink for use with polyhedrons configured with a plurality of surface mounted Light Emitting Diodes.

### DETAILED DESCRIPTION OF THE INVENTION

Designing a light emitting diode lamp to meet Energy Star requirements while still providing the desired light output and long life is a tough challenge. Chips are more efficient when operated at lower drive currents, but using more chips increases the cost. Power generates heat, which damages the chips, but is necessary to obtain output.

A good design must consider the balance of light output, power, physical size, generated heat and the capacity to conduct the heat away from the surface mount light emitting diodes

Polyhedrons are three-dimensional objects characterized by the surfaces on the polyhedrons. When the angle between the surfaces is the same (dihedral symmetry), the object is called a Uniform Polyhedron. Pyramids and cubes are uniform polyhedrons.

When the object has two parallel vertices (and thus two parallel base surfaces), the object is known as a Prismatic Uniform Polyhedron.

Prismatic Uniform Polyhedrons exist in two infinite families, the uniform prisms, in which the polygons in each plane are congruent and joined by rectangles or parallelograms; and the uniform antiprisms, in which the polygons in each plane are congruent and joined by an alternating strip of triangles.

Truncated Prismatic Polyhedrons have the general appearance of a prismatic uniform polyhedrons, but each original vertex is cut off with a new face filling the gap. Truncated Prismatic Polyhedrons are classed according the changes in the original sides, such as ¼ truncated, uniform truncated, ¾ truncated, and rectified.

Certain polyhedra offer a balance of a high coefficient of heat dissipation and 360° lighting symmetry. Those with the greatest uniformity of width, and without need of standoff posts, (Prismatic Uniform Polyhedron and Truncated Prismatic Polyhedron) offer the best heat dissipation, while those that have the most effective number of uniform facings (the Uniform Polyhedrons) offer the most even light distribution.

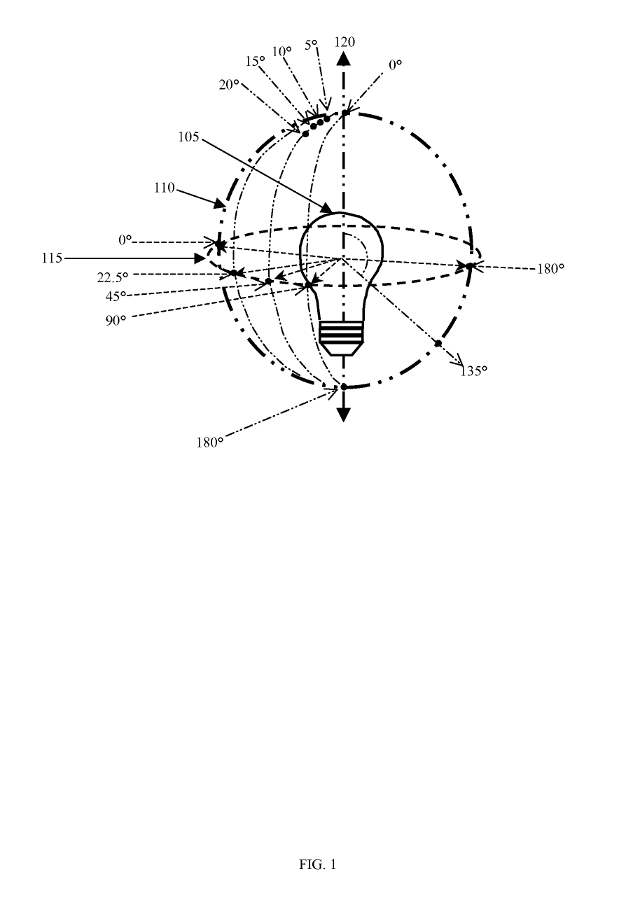

FIG. 1 shows a diagram of a luminous intensity distribution diagram for an omnidirectional lamp. The lamp is hypothetically intended to meet a certain illumination standards approximately consistent with lighting products typically used by consumers. Energy Star is a certification program intended to improve energy efficiency while maintaining product delivery. Given the billions of light bulbs in the U.S., Energy Star bulbs would promise to save a lot of energy.

Shown in FIG. 1 are a light bulb (105), a vertical curve around the lamp (110), a horizontal curve around the lamp (115) and a polar axis (120), as well as points on the vertical curve at 5-degrees, 10-degrees, 15 degrees, 20-degrees, 135 degrees, and 180-degrees, and points on the horizontal curve at 0-degrees, 22.5-degrees, 45-degrees, 90-degrees and 180-degrees. For clarity, different forms of dashed lines distinguished the lines along the vertical plane and the horizontal plane.

In brief, luminosity measurements are made in candelas along the vertical curve at points no more than 22.5-degrees apart, while luminosity measurements are made along the horizontal curve at 0-degrees, 45-degrees, and 90-degrees. The requirement is that the luminous intensity at any vertical angle shall not differ from the mean luminous intensity for the entire 0° to 135° zone by more than 20% with at least 5% of total flux (lumens) emitted in the 135° to 180° zone. This in effect means the lamp has to cover an approximation of 360-degrees to be Energy Star compliant.

Consequently, to meet Energy Star requirements, there must enough surface mount Light Emitting Diodes to meet the consumer's legacy lighting requirement and cover more than 270-degrees (135×2) to meet the 5% requirement in the 135° to 180° zone, but consume less than the maximum permitted energy, and not generate too much heat to diminish the life of the lamp below reasonable expectations.

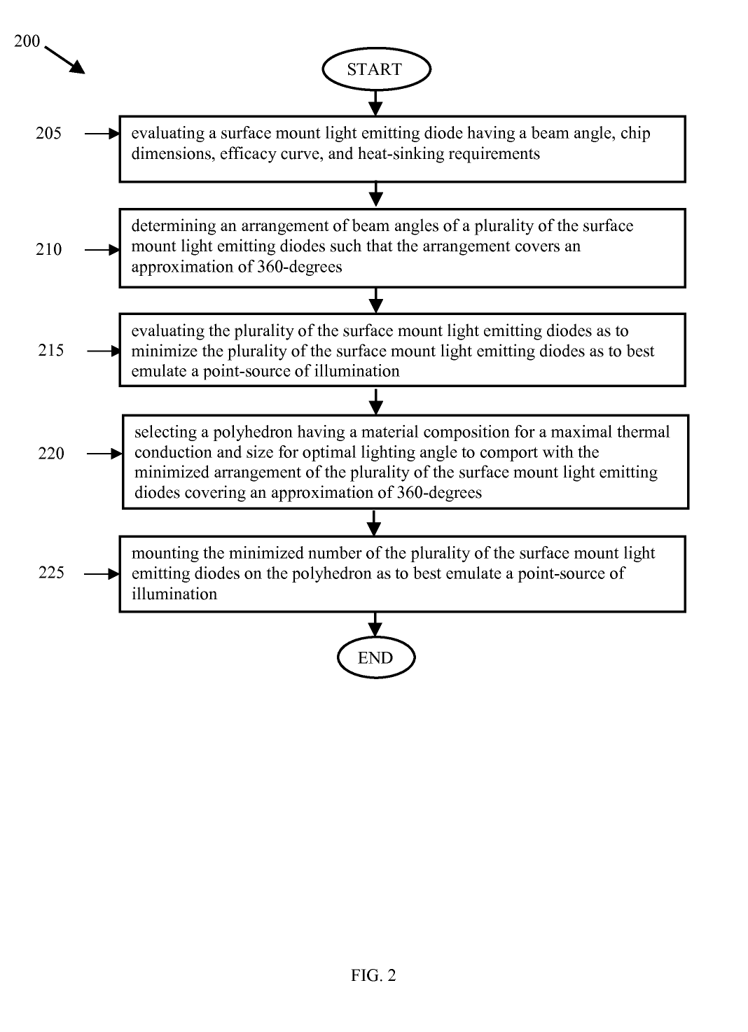

FIG. 2 shows a method (200) of making an LED lamp comprising a minimized number of surface mount light emitting diodes on a polyhedron as to best emulate a point-source of illumination while covering an approximation of 360-degrees to be Energy Star compliant.

Step 205 comprises evaluating a surface mount light emitting diode having a beam angle, chip dimensions, efficacy curve, and heat-sinking requirements. The goal here is to select a surface mount light emitting diode that exceeds or at least meets Energy Star standards for light pattern with an optimum light output angle and chip to match to a polyhedron and available heat conductors. The efficacy curve is helpful to determine power requirements against light output needs.

Step 210 comprises determining an arrangement of beam angles of a plurality of the surface mount light emitting diodes such that the arrangement covers a rough approximation of 360-degrees. As discussed in FIG. 1, 5% of the light must be in the 135° to 180° zone, meaning covering an approximation of 360-degrees to be Energy Star compliant.

Step 215 comprises evaluating the plurality of the surface mount light emitting diodes as to minimize the plurality of the surface mount light emitting diodes as to best emulate a point-source of illumination.

Step 220 comprises selecting a polyhedron having a material composition for a maximal thermal conduction and size for optimal lighting angle to comport with the minimized arrangement of the plurality of the surface mount light emitting diodes covering an approximation of 360-degrees.

Step 225 comprises mounting the minimized number of the plurality of the surface mount light emitting diodes on the polyhedron as to best emulate a point-source of illumination.

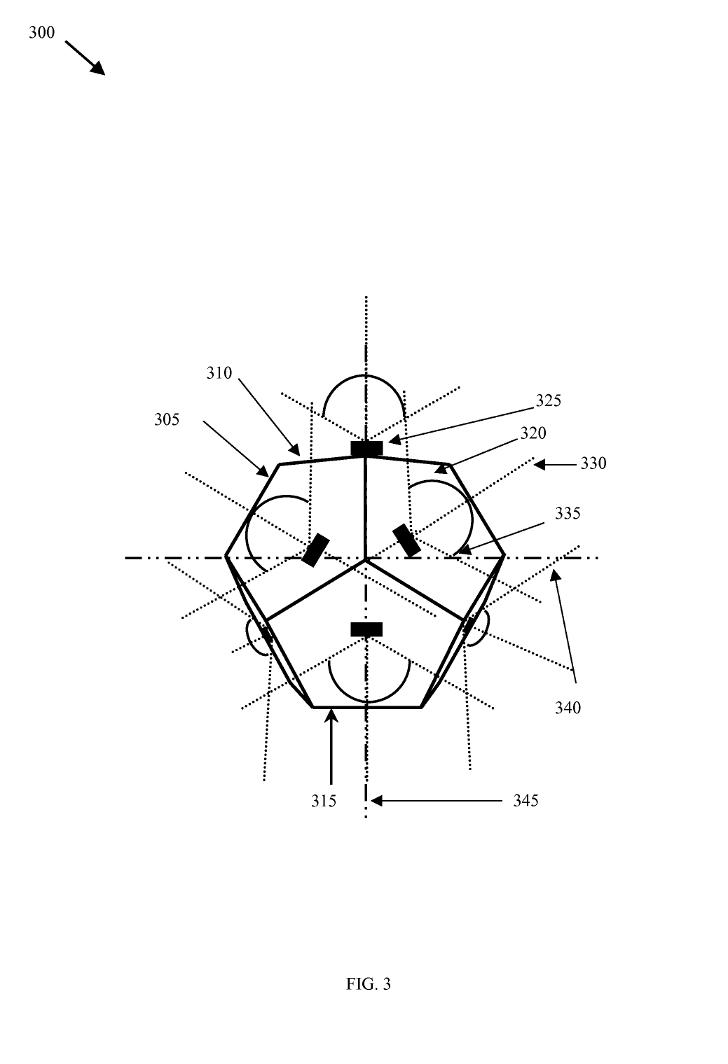

FIG. 3 shows an exemplary embodiment (300) of an optimized and minimized surface mount light emitting diode lamp arrangement showing the light dispersion pattern of a Dodecahedron (12-sided polyhedron) configured with a plurality of Light Emitting Diodes using the method above.

Shown in FIG. 3 are the dodecahedron (305) with an upper two surface (310), a lower parallel surface (315), a total of 10 adjacent faces (320) (five per parallel face) that are tilted 45 degrees from the respective parallel faces, a plurality of light emitting diodes (325), a line (330) representing the path of light perpendicular to a light emitting diode, two lines and an arc (335) representing the peripheral path of light from a light emitting diode, and lines representing the horizontal plane (340) and vertical plane (345).

The 180-degree orientation of the two parallel faces (310 and 315) places the adjacent faces of the upper parallel surface at 90 degrees to the adjacent faces of the lower parallel surface. As each parallel surface is a pentagon, this places the adjacent faces of each parallel surface in a rotation around the upper and lower parallel surfaces at 72 degrees. Because the adjacent faces having a base along the upper parallel surface are equiangular and the same size as the adjacent faces having a base along the lower parallel surface, these adjacent faces are at an angle of 45 degrees to the parallel face along their bases, so their orthogonal projections (perpendicular lines) are 90-degrees to each other.

Surface mount light emitting diodes (325) are available in many different configurations. One among these configurations, has an optimum lighting angle of 60-degrees from the perpendicular, or said another way, 120-degrees from peripheral to peripheral. Though only one light emitting diode is shown here, each adjacent face may have a plurality of surface mount light emitting diodes.

As shown in FIG. 3, the peripheral edge light (335) from the light emitting diodes on each parallel face is nearly parallel to the perpendicular light of its adjacent faces with only a minor overlap. Similarly, the peripheral edge light of each adjacent face is nearly parallel to the peripheral edge light of each adjacent face of bordering the adjacent faces to the opposite parallel face.

Consequently, the light from the surface mount light emitting diodes (325) on a dodecahedron polyhedron (305) overlaps only to minor extent with any adjacent face. The result is that by a desired light output may be achieved with an optimum number of each surface mount light emitting diodes (320) on each face of the dodecahedron polyhedron (305), is light without dark or blinding regions. There may still, however, be a problem with meeting heat dissipation needs.

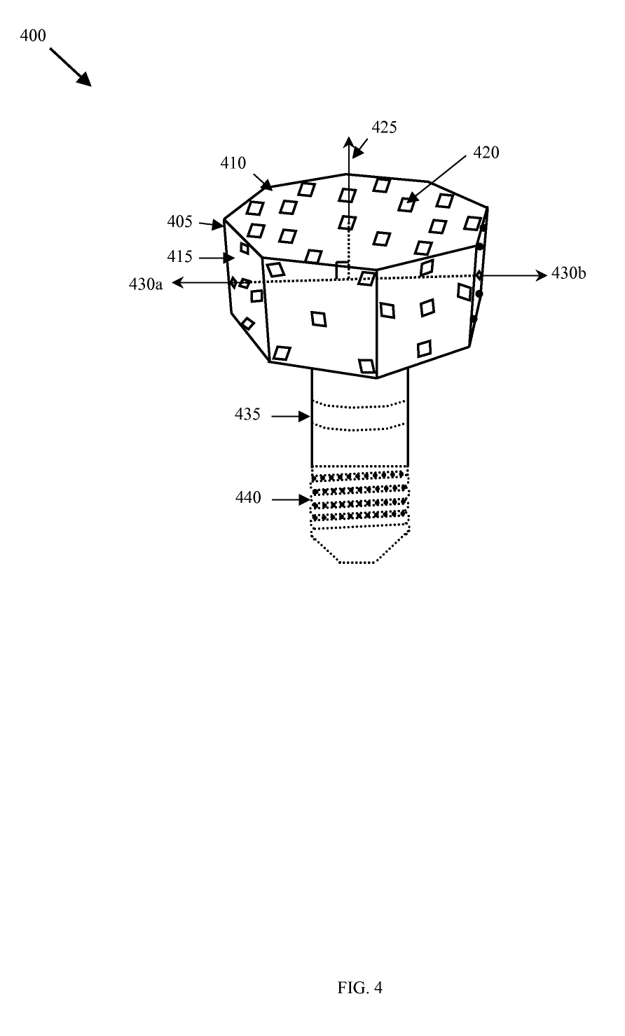

FIG. 4 shows an embodiment (400) of a semiregular polyhedron known as a prismatic uniform polyhedron configured with a plurality of light emitting diodes. This specific polyhedron is known an octagonal prism (400).

Shown in FIG. 4 are prismatic uniform polyhedron (405), the upper parallel surface (410) of the prismatic uniform polyhedron (410), a plurality of uniform polygons (415) on the sides of the prismatic uniform polyhedron (405), a plurality of surface mount light emitting diodes (420), an orthogonal projection (425) of the upper parallel surface (410), two orthogonal projection (430a and 430b) of two of the plurality of uniform polygons (415), a heat conductor (435) and optionally, base adapter (440).

The prismatic uniform polyhedron (405) may be any prismatic uniform polyhedron. Other prismatic uniform polyhedrons may include triangular prism, pentagonal prism, hexagonal prism, decagonal prism, and dodecagonal prism.

The polyhedra may be made of any number of heat or electrically conductive or non-conductive metals or alloys, plastics, polymers, minerals or crystals, or biological or organic substrates, such as and including Organic LEDs.

The upper parallel surface (410) of the prismatic uniform polyhedron (405) serves as a mounting surface for surface mount light emitting diodes that point away perpendicularly (425) from orthogonal projections (430a and 430b) of the plurality of uniform polygons (415) on the sides of the prismatic uniform polyhedron (405). In some embodiments, the upper parallel surface (410) may serve as part of the heat sink.

The plurality of uniform polygons (415) of the prismatic uniform polyhedron (405) serve as mounting surfaces for the surface mount light emitting diodes (420) for illumination to the side and obliquely from the sides. In this embodiment featuring an octagonal prism, the uniform polygons (415) have the shape of squares.

In embodiments of other semiregular polygons, the plurality of uniform polygons (415) may be triangles, squares, pentagons, hexagons, heptagons, octagons, or higher order polygons.

The plurality of surface mount light emitting diodes (420) serve as the source of illumination by converting electrical energy to light. The plurality of surface mount light emitting diodes (420) are typically soldered or otherwise mechanically connected to the upper surface (410) and the plurality of uniform polygons (415).

The heat conductor (435) may be any material and design capable to absorbing and dissipating more heat. The preferred embodiments of the heat conductor is discussed further below. Though shown as if directly connected to the prismatic uniform polyhedron (405), the heat conductor (435) may be connected to the prismatic uniform polyhedron (405) via a standoff post, attachment plate, or other means (not shown) or attached to the upper surface as described below.

The base adapter (435) may be any adapter as appropriate for coupling to a supply of power, including variations of the Edison screw base.

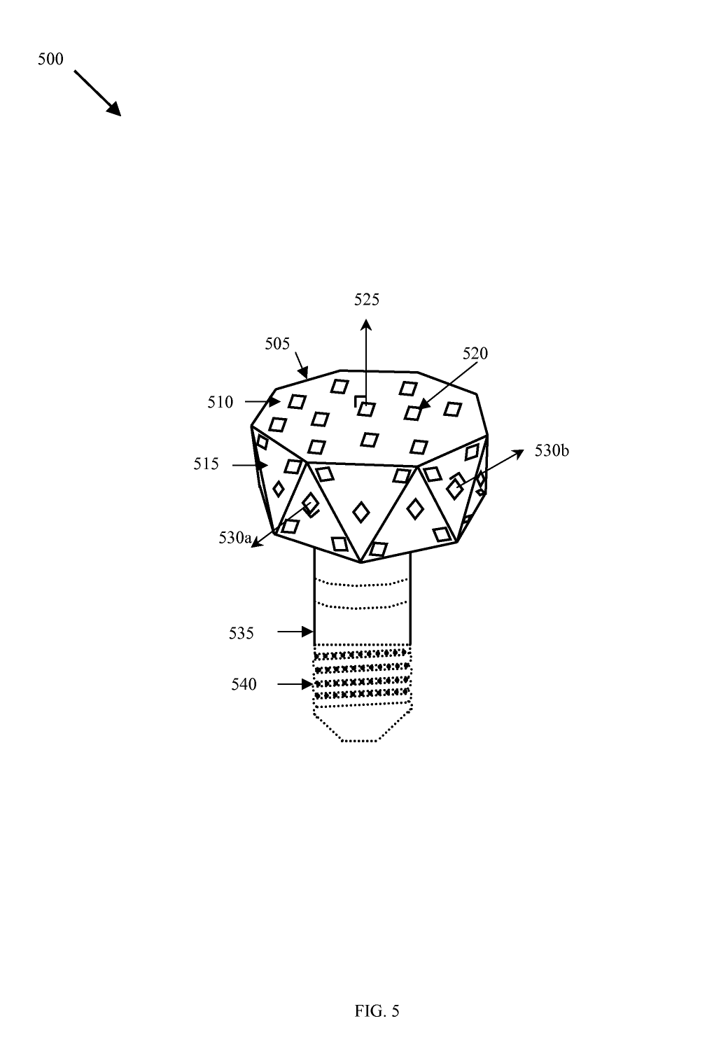

FIG. 5 shows an embodiment (500) of a semiregular prismatic uniform polyhedron antiprism known as an octagonal antiprism configured with a plurality of light emitting diodes as a light emitting diodes Lamp. Like the octagonal prism of FIG. 4, an octagonal antiprism comprises 2 regular octagons as upper and lower surfaces.

Shown in FIG. 5 are the semiregular prismatic uniform polyhedron antiprism (octagonal antiprism, 505), an upper parallel surface (510) of the semiregular prismatic uniform polyhedron antiprism, a plurality (16) of side surfaces (515) of the semiregular prismatic uniform polyhedron antiprism, a plurality of surface mount light emitting diodes (520) on the surfaces, an orthogonal projection (525) of the upper parallel surface (510), an orthogonal projection (530a and 530b) of the plurality of uniform polygons (515), a heat conductor (535) and optionally, base adapter (540).

The octagonal antiprism (505) is a semiregular polyhedron in the family of prismatic uniform polyhedrons. A lower parallel surface is not shown. The distinguishing factor of this semiregular prismatic uniform polyhedron antiprism, like all antiprisms, is that the orthogonal projection (perpendicular lines 530a and 530b) of the side surfaces (515) are not horizontally coplanar as they are with an octagonal prism (see FIG. 4).

While the side surfaces of an octagonal prism are at 90-degrees to both the upper and lower surfaces, the side surfaces (515) of an octagonal antiprism alternate orientation at angles of 60-degrees to the parallel surface along which the base lies while the side surface at the apex is at 120-degrees to the parallel surface adjacent to it. Thus, the orthogonal projections of eight of the side surfaces point slightly upwards, while the orthogonal projections of the eight interposed side surfaces point slightly downwards.

Similarly, as shown in FIG. 3, the benefit of the antiprism polygons (515) is that the peripheral light from surface mount light emitting diodes (520) on the side surfaces (515) is projected at angles near the orthogonal projection of the surface adjacent to the base (i.e., straight up or straight down). This has the effect to allow the lamp to project light covering an approximation of 360-degrees.

Other antiprisms include the square antiprism, the pentagonal antiprism, the hexagonal antiprism, the decagonal antiprism, the dodecagonal antiprism, or any n-gonal antiprism.

The plurality of surface mount light emitting diodes (520) may be any configuration of surface mount light emitting diodes such that the beam angle of the surface mount light emitting diodes is complimentary to the polygon used.

The heat conductor (535) may be any material and design capable of absorbing and dissipating more heat. The preferred embodiments of the heat conductor is discussed further below. Though shown as if directly connected to the prismatic uniform polyhedron antiprism (505), the heat conductor (535) may be connected to the semiregular prismatic uniform polyhedron antiprism (505) via a standoff post, attachment plate, or other means (not shown) or attached to the upper surface as described below.

The base adapter (540) may be any base adapter as appropriate for energy coupling.

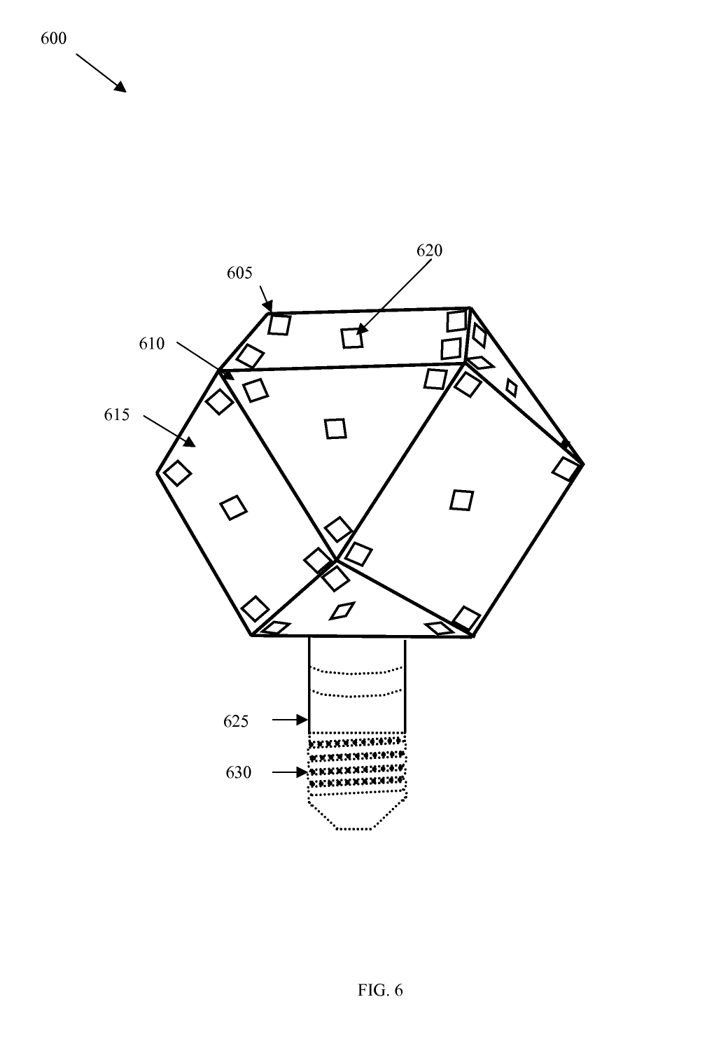

FIG. 6 shows an embodiment (600) of a Truncated Prismatic Uniform Polyhedron known as a Cuboctahedron (a truncated cube) which is also part of a finite group known as Archimedean solids, configured with a plurality of surface mounted light emitting diodes.

Shown in FIG. 6 are an exemplary Truncated Prismatic Uniform Polyhedron (here, a cuboctahedron, (605), a plurality of first surfaces (610) of the Truncated Prismatic Uniform Polyhedron (605), a plurality of second surfaces (615) of the Truncated Prismatic Uniform Polyhedron (605), a plurality of surface mount light emitting diodes (620) on the first and second surfaces, a heat conductor (625) and optionally, base adapter (630).

An Archimedean solid is a highly symmetric, semi-regular convex polyhedron composed of two or more types of regular polygons meeting in identical vertices. Archimedean solids include the truncated tetrahedrons, truncated cubes, truncated octahedrons, rhombicuboctahedrons, truncated cuboctahedron, snub cubes, icosidodecahedrons, truncated dodecahedrons, truncated icosahedrons, rhombicosidodecahedrons, truncated icosidodecahedrons, and snub dodecahedrons. Though the Truncated Prismatic Uniform Polyhedron shown here has only two surface types, a Truncated Prismatic Uniform Polyhedron may have other surface types, depending on the starting shape (cube or other polyhedron) and the degree of truncation.

Unlike other polygons, the orthogonal projections of a surface of an Archimedean solid may or may not be perpendicular, or even parallel to other surfaces of an Archimedean solid.

The plurality of surface mount light emitting diodes (620) may be any configuration of surface mount light emitting diodes such that the beam angle of the surface mount light emitting diodes is complimentary to the polygon used. The method discussed above therefore requires specific evaluations of which polygon and side the surface mount light emitting diode will be attached to.

The heat conductor (625) may be any material and design capable of absorbing and dissipating more heat. The preferred embodiments of the heat conductor is discussed further below. Though shown as if directly connected to the Archimedean solid (605), the heat conductor (625) may be connected to the prismatic uniform polyhedron (605) via a standoff post, attachment plate, or other means (not shown) or attached to the upper surface as described below.

The base adapter (530) may be any base adapter as appropriate for energy coupling.

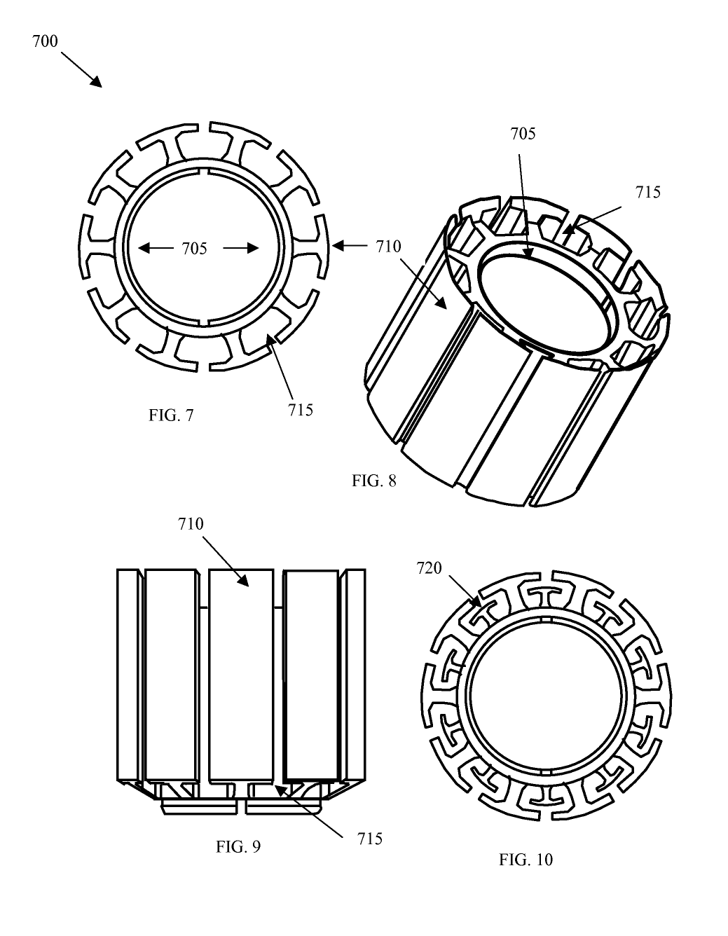

In reference to FIGS. 7, 8, 9 and 10, using surface mount light emitting diodes is a difficult and conflicting problem. Most surface mount light emitting diodes generate a modest amount of light in contrast to a significant amount of heat. To increase light output, larger or more surface mount light emitting diodes are used. But because heat content increases geometrically with area, surface mount light emitting diodes are generally small to prevent them from frying themselves.

So, because of these problems, the typical solution for increasing light output and decreasing heat is to place many small surface mount light emitting diodes as far apart as possible and use heat conductors and diffusers to solve the engineering problems. However, if there are not enough surface mount light emitting diodes, dark regions are present. If there are too many surface mount light emitting diodes, unusual bright regions are present and the surface mount light emitting diodes may burn out.

FIGS. 7, 8, 9 and 10, shows a specially designed heat sink for use with polyhedrons configured with a plurality of surface mounted light emitting diodes. FIG. 7 shows a top view. FIG. 8 shows an oblique view. FIG. 9 shows a partial side view. FIG. 10 shows a top view of another embodiment of the specially designed heat sink for use with polyhedrons configured with a plurality of surface mounted light emitting diodes.

In these figures is an exemplary Radial Heat Conductor with Curved-T Heat Fins (700), for use with surface mount light emitting diodes on polyhedrons (not shown). Comprising the exemplary heat conductor (700) is a support core (705) and around the support core (705) is a plurality of curved-T shaped heat fins (710). In between the plurality of curved-T shaped heat fins (710) are a plurality of interstitial channels (715). Some embodiments, as shown in FIG. 10, contain a secondary plurality of curved-T shaped heat fins (720).

As mentioned above, heat generation increases geometrically with surface area. Heat dissipation, on the other hand, increases by the square of the size. As such, heat conductors follow the formula of making them bigger with more straight fins to remove heat, or adding secondary heat conductor systems (i.e., fluids) to augment the primary heat sink.

Heat, however, follows three rules, conduction—heat travels through contact with any surface, convection—heat rises into the surrounding air, and in doing so, will create an air current comporting with the physical constraints around the heat generator, and radiation—infrared waves radiating away the heat.

Many heat conductors use straight fins for a combination of convention and radiation. While inexpensive to make, straight fin heat conductors are not highly effective because in part, straight fins increase surface area only by the square of their size, they do not create heat transfer channels and adjacent fins block fin radiation.

A Radial Heat Conductor with Curved-T Heat Fins (700), on the other hand, geometrically increases the surface area at the heat transfer boundary with only a minimal increase in heat conductor size. In addition, the spacing between the support core (705) the Radial Curved-T Heat Fins (710) creates a plurality of interstitial channels (715). The heat buildup in the interstitial channels (715) creates passive airflow past the Radial Curved-T Heat Fins (710), which increases heat dissipation from the Radial Heat Conductor (700).

Some embodiments comprise a single radial set of plurality of curved-T shaped heat fins (710). In some embodiments, a secondary radial plurality of curved-T shaped heat fins (720) are within the interstitial spaces of the primary plurality of curved-T shaped heat fins (715). The secondary radial plurality of curved-T shaped heat fins (720) increase the surface area of the Radial Heat Conductor to increase heat dissipation.

A Radial Heat Conductor with Curved-T Heat Fins (700) may be made of any heat conductive material. In some embodiments, as shown in FIG. 10, the Radial Heat Conductor with Curved-T Heat Fins (700) is made of copper. In some embodiments, the Radial Heat Conductor with Curved-T Heat Fins (700) is made of aluminum. In some embodiments, the Radial Heat Conductor with Curved-T Heat Fins (700) is made of ceramic. The Radial Heat Conductor with Curved-T Heat Fins (700) may be made of plastic or a polymer or any heat conductive material. In some embodiments, the radial heat conductor is hollow. In some embodiments, the radial heat conductor is substantially solid.

In some embodiments, the Radial Heat Conductor with Curved-T Heat Fins contains a working fluid to assist heat dissipation. The working fluid may be air, water, or other vapor or liquid fluid.

In some embodiments, the Radial Heat Conductor with Curved-T Heat Fins (700) may inserted into a polyhedron (such as the polyhedron in FIG.4) on which are mounted a plurality of surface mounted light emitting diodes and affixed inside the polyhedron to draw heat away from within the polyhedron, i.e., the interior of the polyhedron. As such, this also draws heat away from the exterior of the polyhedron.

These descriptions and drawings are embodiments and teachings of the present invention. All variations are within the spirit and scope of the present invention. This disclosure is not to be considered as limiting the present invention to only the embodiments illustrated.

What is claimed is:

1) A method of making an LED light bulb comprising:
evaluating a surface mount light emitting diode having a beam angle, chip dimensions, efficacy curve, and heat-sinking requirements,
determining an arrangement of beam angles of a plurality of the surface mount light emitting diodes such that the arrangement covers a rough approximation of 360-degrees,
evaluating the plurality of the surface mount light emitting diodes as to minimize the plurality of the surface mount light emitting diodes as to best emulate a point-source of illumination,
selecting a polyhedron having a material composition for a maximal thermal conduction and size for optimal lighting angle to comport with the minimized arrangement of the plurality of the surface mount light emitting diodes covering an approximation of 360-degrees, and
mounting the minimized number of the plurality of the surface mount light emitting diodes on the polyhedron as to best emulate a point-source of illumination.

2) The method of making an LED light bulb of claim 1 wherein the polyhedron is an uniform prism.

3) The method of making an LED light bulb of claim 1 wherein the polyhedron is an uniform antiprism.

4) The method of making an LED light bulb of claim 1 wherein the polyhedron is a regular polyhedron.

5) The method of making an LED light bulb of claim 1 wherein the polyhedron is a semiregular polyhedron.

6) The method of making an LED light bulb of claim 1 wherein the polyhedron is an Archimedean solid.

7) The method of making an LED light bulb of claim 1 further comprising attaching a heat conductor to the polyhedron that has a radial cross-section surrounded by a plurality of curved T-shaped heat fins.

8) The method of making an LED light bulb of claim 1 further comprising inserting a heat conductor into the polyhedron for drawing heat away from an interior space of the polyhedron.

9) An LED light bulb made using a method comprising the steps of:
evaluating a surface mount light emitting diode having a beam angle, chip dimensions, efficacy curve, and heat-sinking requirements,
determining an arrangement of beam angles of a plurality of the surface mount light emitting diodes such that the arrangement covers a rough approximation of 360-degrees,
evaluating the plurality of the surface mount light emitting diodes as to minimize the plurality of the surface mount light emitting diodes as to best emulate a point-source of illumination,
selecting a polyhedron having a material composition for a maximal thermal conduction and size for optimal lighting angle to comport with the minimized arrangement of the plurality of the surface mount light emitting diodes covering an approximation of 360-degrees, and
mounting the minimized number of the plurality of the surface mount light emitting diodes on the polyhedron as to best emulate a point-source of illumination.

10) The light bulb of claim 9 wherein the light bulb has a plurality of luminous intensities measured in values of candelas of which 90% shall vary by no more than 25% from an average of all measured values, and all measured values in candelas vary by no more than 50% from the average of all measured values, and the light bulb has a 135° to 180° zone in which no less than 5% of total flux measure in values of zonal lumens are emitted.

11) A light bulb comprising a plurality of surface mount light emitting diodes affixed to a plurality of outside surfaces comprising a semi-regular polyhedron.

12) The light bulb of claim 11 further comprising a heat conductor comprising a support core, a plurality of curved-T shaped heat fins around the support core, and a plurality of interstitial channels between the plurality of curved-T shaped heat fins.

13) A heat conductor for use with a plurality of surface mounted light emitting diodes affixed to a semiregular polyhedron comprising a support core, a plurality of curved-T shaped heat fins around the support core, and a plurality of interstitial channels between the plurality of curved-T shaped heat fins.

14) The heat conductor of claim 13 wherein the heat conductor is hollow.

15) The heat conductor of claim 13 wherein the heat conductor contains a working fluid.

16) The heat conductor of claim 13 wherein the heat conductor is substantially solid.

17) The heat conductor of claim 13 wherein the heat conductor comprises a material selected from the group consisting of copper, aluminum, ceramic and a polymer.

18) The heat conductor of claim 13 wherein the heat conductor further comprises a plurality of curved-T shaped heat fins interspersed within the plurality of interstitial channels between the plurality of curved-T shaped heat fins.

19) A method of making an LED light bulb comprising:
matching a light output of a plurality of surface mount light emitting diodes to a predetermined light output requirement,
selecting a polyhedron having a suitable size for the plurality of surface mount light emitting diodes,
selecting a thermally conductive material for the polyhedron suitable for affixing the surface mount light emitting diodes,
selecting a thermally conductive material for a heat sink,
affixing the surface mount light emitting diodes and power supply to the polyhedron, and
affixing the heat sink to the polyhedron.
